(19) United States
(12) Patent Application Publication
(10) Pub. No.: US 2010/0025938 A1
(43) Pub. Date: Feb. 4, 2010

(54) Bearing Seal

(75) Inventors: Alexander Berdichevsky, Farmington Hills, MI (US); Kevin Randal Colby, Bridgewater, NH (US); Lori Anne Cieslinski, Howell, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/302,983

(22) PCT Filed: Jun. 7, 2007
(86) PCT No.: PCT/US07/13441

§ 371 Date: Apr. 23, 2009

Related U.S. Application Data
(60) Provisional application No. 60/804,127, filed on Jun. 7, 2006.

(51) Int. Cl. F16J 15/32

(52) U.S. Cl. 277/562

(57) ABSTRACT

A bearing seal is provided with an annular outer casing having an axially extending portion and a radially inwardly extending portion. A sleeve member is disposed within the annular casing and includes an axially extending portion adapted to be attached to a rotating shaft and a radially outwardly extending portion. An annular seal including a seal body is mounted to the annular casing. A first seal lip extends axially from the seal body and engages the radially outwardly extending portion of the sleeve member. A dual contact lip extends from the seal body and includes a first seal portion and a second seal portion each contacting the sleeve member at axially spaced locations.

### CROSS-REFERENCE TO RELATED APPLICATIONS

This application is a National Stage of International Application No. PCT/US07/13441, filed Jun. 7, 2007, which claims the benefit of U.S. Provisional Application No. 60/804,127, filed on Jun. 7, 2006. The disclosures of the above applications are incorporated herein by reference.

### FIELD

The present disclosure relates to seals, and more specifically to bearing seals.

### BACKGROUND AND SUMMARY

The function of bearing seals is to protect bearings from environmental harshness—water, slurry, dust, etc.—and at the same time to provide grease retention in the bearing chamber.

One complication is the need to vent hot air from the bearing case, which is generated by friction and external heat sources. A further challenge is to maintain proper contact forces and contact load profiles in all possible combinations of installation characteristics and tolerance stackup. An additional constraint is having total torque generated by the seal to reduce, at a minimum, under-lip temperature build-up, and thus prevent early thermal degradation of the seal (not to mention wasted energy).

The bearing seal of the present disclosure includes an annular casing having an axially extending portion adapted to be attached to a fixed housing member and a radially inwardly extending portion. A sleeve member includes an axially extending portion adapted to be attached to a rotating shaft and a radially outwardly extending portion. An annular seal includes a seal body mounted to the casing, a first seal lip extends axially from the seal body and engages the radially outwardly extending portion of the sleeve member. A dual-contact lip extends from the seal body and includes a first seal portion and a second seal portion each contacting the sleeve member at axially spaced locations.

According to one aspect, the dual-contact lip can include an axially extending portion extending from the seal body and the dual-contact lip is folded under the axially extending portion in contact with the sleeve member.

### DRAWINGS

The drawings described herein are for illustration purposes only and are not intended to limit the scope of the present disclosure in any way.

FIG. 1 is a cross-sectional view of a bearing seal according to the principles of the present disclosure shown in an installed position; and

FIG. 2 is a cross-sectional view of the bearing seal of FIG. 1 shown in an uninstalled position.

### DESCRIPTION

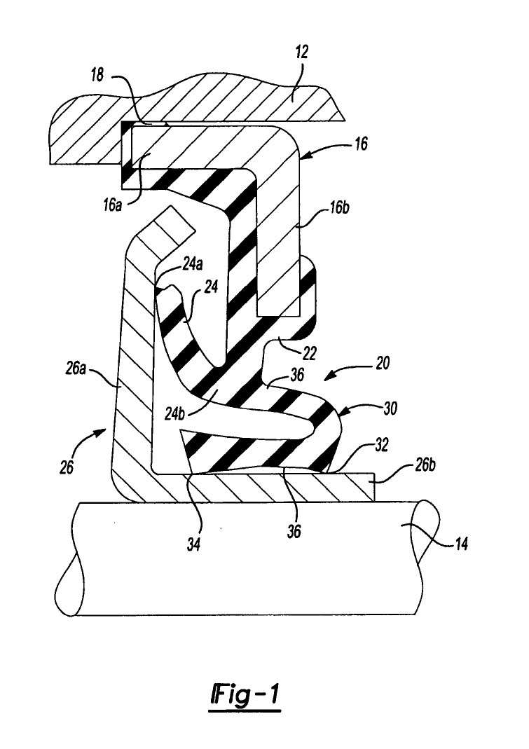

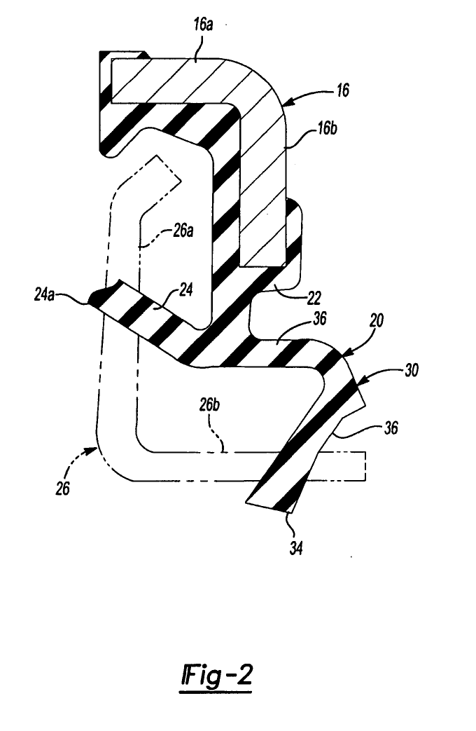

With reference to FIGS. 1 and 2, the bearing seal 10 of the present disclosure will now be described. The bearing seal 10 is shown in FIG. 1 in an installed condition and in FIG. 2 is shown before installation. The bearing seal 10 was designed to be inserted in a housing or other fixed member 12 and is designed to be received on a shaft 14 or other rotary member. The bearing seal includes an annular outer casing insert 16 having an axially extending portion 16a adapted to be attached to the housing or other fixed member 12, and includes a radially inwardly extending portion 16b. The annular casing 16 can be over-molded with elastomeric material 18 so as to enhance the sealing contact with the housing 12.

An annular seal 20 includes a seal body 22 mounted to the casing 16 such as by molding or other attachment techniques. A first seal lip 24 extends axially from the seal body 22 and engages a radially outwardly extending portion 26a of a sleeve member 26 which is mounted to the shaft 14. The sealing lip 24 includes a distal sealing edge 24a in contact with the radially outwardly extending portion 26a of the sleeve 26. The seal lip 24 is deformed in the installed position as shown in FIG. 1, and as shown in FIG. 2 has an uninstalled shape that extends axially and slightly radially outward relative to its base portion 24b where it is connected to the seal body 22.

A dual-contact lip 30 extends from the seal body 22 and includes a first seal portion 32 and a second seal portion 34 each contacting an axially extending portion 26b of the sleeve member 26 at axially spaced locations. The dual-contact lip 30 has an axially extending portion 36 extending from the seal body and the dual-contact lip 30 is folded under the axially extending portion 36 in contact with the sleeve member 26. The first seal portion 32 is disposed at an intermediate position along the length of the dual-contact lip 30 and the second seal portion 34 is disposed generally at a terminal end of the dual-contact lip 30. As illustrated in FIG. 1, with the dual-contact lip being folded over on itself, the dual-contact lip is self spring loaded to enhance the sealing contact with the sleeve 26. The dual-contact lip is provided with a recessed region 36 disposed between the first seal portion 32 and second seal portion 34 so as to isolate the contact to the first seal portion 32 and second seal portion 34 so as to reduce friction therebetween.

What is claimed is:

1. A bearing seal, comprising:
an annular casing having an axially extending portion and a radially inwardly extending portion, said casing being adapted to be attached to a fixed member;
a sleeve member including an axially extending portion adapted to be attached to a rotating shaft and a radially outwardly extending portion; and
an annular seal including a seal body mounted to said casing, a first seal lip extends axially from said seal body and engaging said radially outwardly extending portion of said sleeve member, and a dual-contact lip extending from said seal body and including a first seal portion and a second seal portion each contacting said sleeve member at axially spaced locations.

2. The bearing seal according to claim 1, wherein said dual-contact lip has an axially extending portion extending from said seal body and said dual-contact lip is folded under said axially extending portion in contact with said sleeve member.

3. The bearing seal according to claim 1, wherein said first seal portion of the dual-contact lip is disposed at an intermediate position along a length of said dual-contact lip.

4. The bearing seal according to claim 3, wherein said second seal portion of said dual-contact lip is disposed generally at a terminal end of said dual-contact lip.

5. A bearing seal, comprising:
an annular casing having an axially extending portion and a radially inwardly extending portion, said casing being adapted to be attached to a fixed member;
a sleeve member including an axially extending portion adapted to be attached to a rotating shaft and a radially outwardly extending portion; and
an annular seal including a seal body mounted to said casing and a dual-contact lip extending from said seal body and including a first seal portion and a second seal portion each contacting said sleeve member at axially spaced locations.

6. The bearing seal according to claim 5, wherein said dual-contact lip has an axially extending portion extending from said seal body and said dual-contact lip is folded under said axially extending portion.

7. The bearing seal according to claim 5, wherein said first seal portion of said dual-contact lip is disposed at an intermediate position along a length of said dual-contact lip.

8. The bearing seal according to claim 7, wherein said second seal portion of said dual-contact lip is disposed generally at a terminal end of said dual-contact lip.
